(19) United States
(12) Patent Application Publication
(10) Pub. No.: US 2013/0260932 A1
(43) Pub. Date: Oct. 3, 2013

(54) TENSIONER AND ENDLESS DRIVE ARRANGEMENT

(71) Applicants: Joern Adam, Gelnhausen (DE); Ingo Walter, Grundau (DE)

(72) Inventors: Joern Adam, Gelnhausen (DE); Ingo Walter, Grundau (DE)

(21) Appl. No.: 13/434,787

(22) Filed: Mar. 29, 2012

(51) Int. Cl. F16H 7/12

(52) U.S. Cl. 474/134

(57) ABSTRACT

A Y-tensioner is provided for tensioning the endless drive of an engine having a starter-generator unit (SGU). First and second arms of the Y-tensioner are pivotable about a common first axis. The second arm is articulated to the first arm and spring-loaded to pivot about a second axis spaced from the first axis. The first arm tensions a first strand of the endless drive which becomes the tight side when the SGU operates as a starter and the second arm tensions the second strand which becomes the tight side when the SGU operates as a generator. Pivoting of the Y-tensioner about the first axis enables the first or second arm to better align with the dominant force on the pulleys as the SGU shifts between starter and generator modes, reducing torque about the second axis to reduce the size of the spring that tensions the two arms together.

### FIELD OF INVENTION

The invention relates generally to the field of tensioners for an endless drive, and more particularly to a belt drive arrangement for a starter-generator unit which uses a Y tensioner.

### BACKGROUND OF INVENTION

An ever increasing number of engines having a starter-generator unit have been developed since the 1990s in order to improve fuel mileage. In such engines, the combustion process is stopped when the vehicle comes to rest, for example, at a stoplight. In this condition the starter-generator unit is operated as a starter motor to restart the engine. Once the engine is started, the starter-generator unit can be selectively operated as a generator to recharge the batteries.

The starter-generator unit is mechanically connected to the engine via an endless drive such as a belt or chain. The endless drive is subject to tension fluctuations, particularly as the starter-generator unit shifts its function between starter and generator, in which case the tight side and slack side of the endless drive reverses. The endless drive tensioning system must handle this and other tension fluctuations that occur whilst the engine is operating.

Various dual arm tensioners are known in the art, example of which are found in publication numbers DE 102 53 450 A1; EP 1 464 871 A1; US 2004/0171448 A1; EP 1 122 464 A1; and DE 42 43 451 A1. However, the invention seeks to provide a more robust solution to effectively compensating for longitudinal shifts occurring in portions of the endless drive as a result of a changeover between the tight side and the slack side.

### SUMMARY OF INVENTION

According to one aspect of the invention an endless drive arrangement for an internal combustion engine is provided. The arrangement includes an endless drive guided around an endless driving wheel of the endless drive arrangement. A starter-generator unit is connected to the endless driving wheel. A tensioner with a first tensioning arm and a second tensioning arm is provided. The first and the second tensioning arms are pivotable about a common first pivot axis, wherein the second tensioning arm is articulated to the first tensioning arm so as to be spring-loaded and pivotable about a second pivot axis located at a distance from the first pivot axis. A first tensioning pulley is rotationally connected to the first tensioning arm about a first axis of rotation, the first tensioning pulley resting against a first strand of the endless drive so as to tension the same. A second tensioning pulley is rotationally connected to the second tensioning arm about a second axis of rotation, the second tensioning pulley resting against a second strand of the endless drive so as to tension the same. The first strand becomes a tight side of the endless drive when the starter-generator unit operates as a starter and the second strand becomes the tight side when the starter-generator unit operates as a generator.

According to another aspect of the invention an endless drive arrangement for an internal combustion engine is provided. The arrangement includes an endless drive guided around an endless driving wheel of the endless drive arrangement. A starter-generator unit connected to the endless driving wheel. A tensioner with a first arm and a second arm is provided. The first and the second arms are pivotable about a common first pivot axis, wherein the second arm is articulated to the first arm and pivotable about a second pivot axis located at a distance from the first pivot axis. A coil spring is connected between the first and second arms so as to bias the arms towards each other. A first pulley is rotationally connected to the first arm about a first axis of rotation, the first pulley resting against a first strand of the endless drive so as to tension the endless drive. A second pulley is rotationally connected to the second arm about a second axis of rotation, the second pulley resting against a second strand of the endless drive so as to tension the endless drive. The first strand becomes a tight side of the endless drive when the starter-generator unit operates as a starter and the second strand becomes the tight side when the starter-generator unit operates as a generator. The first pivot axis is fixed relative to the engine at a position that is substantially in line with a hub force vector experienced by the endless drive wheel when the starter generator unit is in a quasi-static mode of operation.

According to a third aspect of the invention an endless drive arrangement for an internal combustion engine is provided. The arrangement includes an endless drive guided around an endless driving wheel of the endless drive arrangement. A starter-generator unit connected to the endless driving wheel. A tensioner having a first arm and a second arm is provided. The first and the second arms are pivotable about a common first pivot axis, wherein the second arm is articulated to the first arm so as to be pivotable about a second pivot axis located at a distance from the first pivot axis. A coil spring is connected between the first and second arms so as to bias the arms towards each other. A first pulley is rotationally connected to the first arm about a first axis of rotation, the first pulley resting against a first strand of the endless drive so as to tension the endless drive. A second pulley is rotationally connected to the second arm about a second axis of rotation, the second pulley resting against a second strand of the endless drive so as to tension the endless drive. The first strand becomes a tight side of the endless drive when the starter-generator unit operates as a starter and the second strand becomes the tight side when the starter-generator unit operates as a generator. The first pivot axis is fixed relative to the engine and the second pivot axis floats relative to the engine, the second pivot axis being eccentrically positioned away from a line between the first pivot axis and the first axis of rotation. The distance between the first pivot axis and the second pivot axis is at least a third of the distance between the second pivot axis and one of the first axis of rotation and the second axis of rotation.

According to a fourth aspect of the invention an endless drive arrangement for an internal combustion engine is provided. The arrangement includes an endless drive guided around an endless driving wheel of the endless drive arrangement. A starter-generator unit connected to the endless driving wheel. A tensioner having a first arm and a second arm is provided. The first and the second arms are pivotable about a common first pivot axis, wherein the second arm is articulated to the first arm so as to be pivotable about a second pivot axis located at a distance from the first pivot axis. A coil spring is connected between the first and second arms so as to bias the arms towards each other. A first pulley is rotationally connected to the first arm about a first axis of rotation, the first pulley resting against a first strand of the endless drive so as to tension the endless drive. A second pulley os rotationally connected to the second arm about a second axis of rotation, the second pulley resting against a second strand of the endless drive so as to tension the endless drive. The first strand becomes a tight side of the endless drive when the starter-generator unit operates as a starter and the second strand becomes the tight side when the starter-generator unit operates as a generator. The first pivot axis is fixed relative to the engine and the second pivot axis floats relative to the engine, the first pivot axis being situated at a position that is substantially in line with a hub force vector experienced by the endless drive wheel when the starter generator unit is in a quasi-static mode of operation, the second pivot axis being positioned away from a line between the first pivot axis and the first axis of rotation, and wherein the distance between the first pivot axis and the second pivot axis is at least a third of the distance between the second pivot axis and one of the first axis of rotation and the second axis of rotation.

The tensioner of the foregoing aspects of the invention pivots about the common first. This axis enables the first or second tensioning arm to better align with the dominant force on the first or second pulley as the starter-generator unit shifts between the starter and generator modes. This minimizes the torque about the second pivot axis following which the size of the spring needed to tension the two arms together can be reduced.

### BRIEF DESCRIPTION OF DRAWINGS

The foregoing and other aspects of the invention will be more readily appreciated having regard to the accompanying drawings, wherein:

FIG. 1 is a top view of a tensioner according to a preferred embodiment of the invention;

FIG. 2 is a perspective view of the tensioner shown in FIG. 1;

FIG. 3 is a cross-sectional view of the tensioner taken along a line III-III shown in FIG. 2;

FIG. 4 shows a model of the tensioner shown in FIG. 1 in a starter-generator belt drive arrangement in an initial, quasi-static, position;

FIG. 5 shows a model of the tensioner in the belt drive arrangement of FIG. 4 in a first position where the starter-generator operates as a starter;

FIG. 6 shows the model of the tensioner in the belt drive arrangement of FIG. 4 in a second position where the starter-generator operates as a generator; and

FIG. 7 shows the torque characteristics of a starter-generator unit.

### DETAILED DESCRIPTION OF PREFERRED EMBODIMENTS

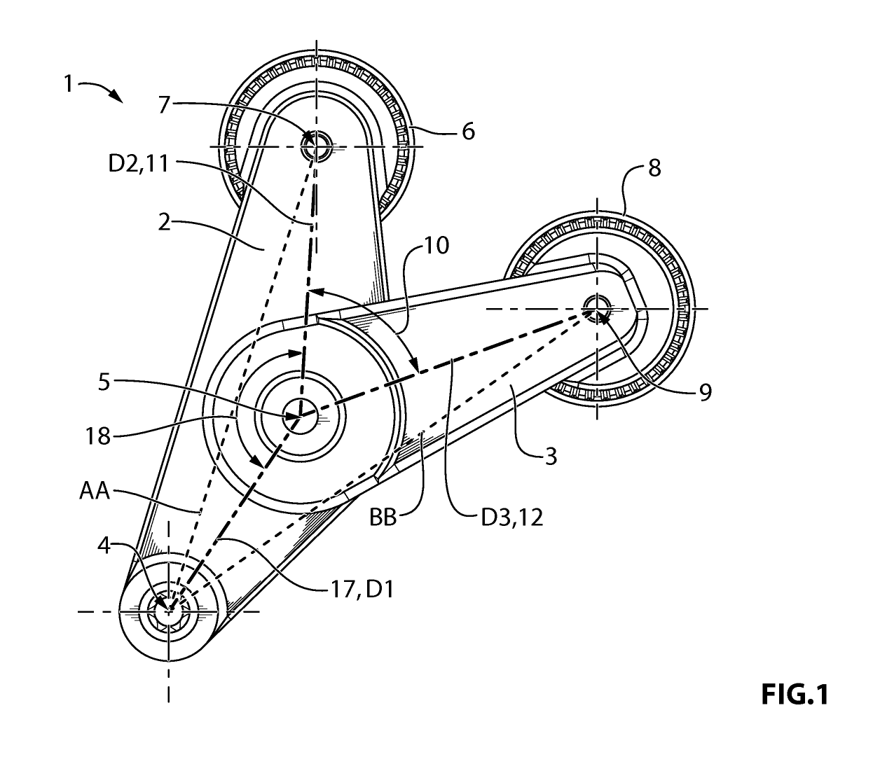

FIG. 1 is a top view of a tensioner 1 according to a preferred embodiment of the invention. The tensioner comprises a first tensioning arm 2 and a second tensioning arm 3. The first tensioning arm 2 is pivotable about a first pivot axis 4. The second tensioning arm 3 is articulated to the first tensioning arm 2 so as to be spring-loaded and so as to be pivotable about a second pivot axis 5. The first tensioning arm 2 supports a first tensioning pulley 6 that is rotatable about a first axis of rotation 7 and the second tensioning arm 3 supports a second tensioning pulley that is rotatable about a second axis of rotation 9.

The second pivot axis 5 is located at a distance from the first pivot axis 4, that is, the second pivot axis is eccentric relative to the first pivot axis. More particularly, the location of the second pivot axis 5 is preferably offset from a line AA between the first pivot axis 4 and the first axis of rotation 7 and from a line BB between the second pivot axis 5 and the second axis of rotation 9.

In the illustrated embodiment the tensioning pulleys 6, 8 are in the form of belt pulleys. However, it is also possible to design the tensioner as a chain tensioner comprising chain sprockets and the tensioner then tensions a chain in the form of an endless drive.

The distance D1 between the first pivot axis 4 and the second pivot axis 5 is at least a quarter of the distance D2 between the second pivot axis 5 and the first axis of rotation 7 and/or the distance D3 to the second axis of rotation 9. Preferably, the distance D1 between the first pivot axis 4 and the second pivot axis 5 is at least a third, more preferably at least half of the distance D2 between the second pivot axis 5 and the first axis of rotation 7 and/or the distance D3 to second axis of rotation 9. Advantageously, the distance D1 between the first pivot axis 4 and the second pivot axis 5 can also be selected to be approximately as large as the distance D2 between the second pivot axis 5 and the first axis of rotation 7 and/or the distance D3 to second axis of rotation 9. In the present exemplary embodiment, the second pivot axis 5 is disposed at an approximately equal distance from the first pivot axis 4, the first axis of rotation 7 and the second axis of rotation 9, i.e., D1, D2 and D3 are approximately the same.

The greater the distance D1 between the first pivot axis 4 and the second pivot axis 5, the smaller can the distances D2 and D3 be between the second pivot axis 5 and the first axis of rotation 7 and the second axis of rotation 9. An opening angle 10 between a first line 11 connecting the second pivot axis 5 to the first axis of rotation 7 and a line 12 connecting the second pivot axis 5 to the second axis of rotation 9 can be selected to be appropriately larger, particularly when the tensioning pulleys 6, 8 are otherwise in the same position.

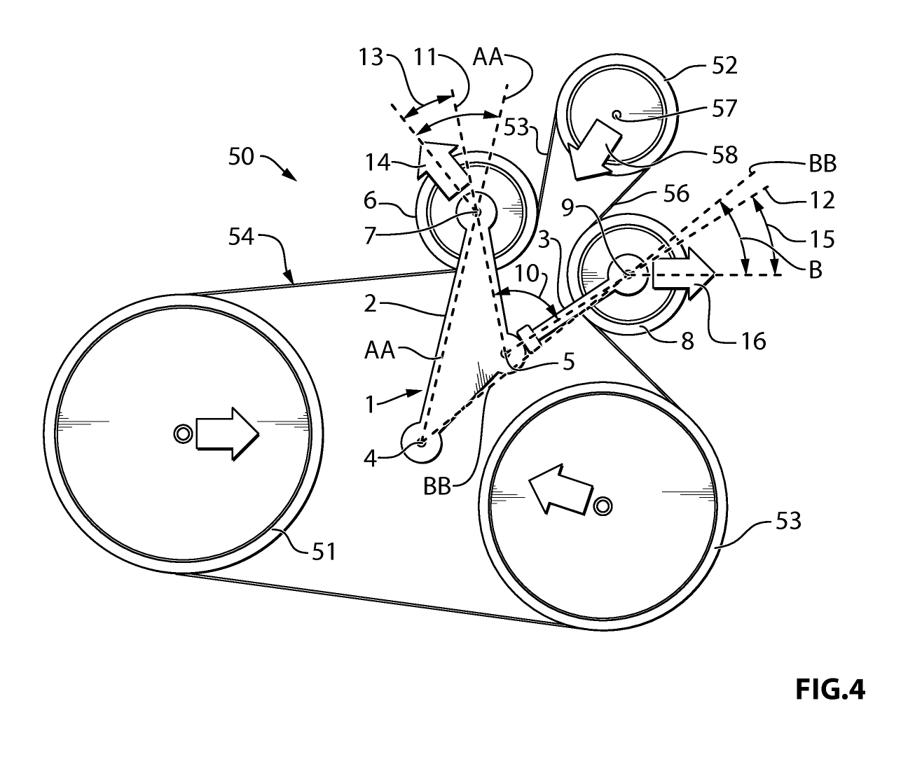

The opening angle 10 can be maintained in the range of 60° and 90°, for example. The larger the opening angle, the smaller are a first angle 13a (see FIG. 4) between a first hub load force introduced by means of the first tensioning pulley 6 and first line 11 (or angle α to line AA) as well as a second angle 15 (see FIG. 4) between a second hub load force introduced by means of the second tensioning pulley 8 and the second line 12 (or angle β o line BB). The smaller the first and the second angles 13 and 15 (or α and β), the higher is the respective resulting force component that is absorbed as tensile force by the tensioning arm in question. As a result, the spring force required for tensioning the tensioning arms 2, 3 becomes smaller. In the case of an opening angle 10 in the range of 60° to 90°, the tensioning arms do not open that markedly even when the belt tension increases sharply as a result of the operation of the belt drive arrangement. That is, the wrap angle of a belt pulley, of which the strand is tensioned by the tensioner 1, reduces less sharply.

In spite of that, longitudinal shifts occurring in the belt, for example, during a changeover between the tight side and the slack side, can be compensated effectively by the tensioner 1 by means of the distance D1 between the first pivot axis 4 and the second pivot axis 5 as selected according to the present invention.

In the present exemplary embodiment, the first line 11 and a third line 17 connecting the first pivot axis 4 to the second pivot axis 5 form an obtuse angle 18 (see FIG. 1) that is preferably in the range of 140° to 175°. As a result, it is possible to reduce the length of the second tensioning arm 3 as compared to a stretched form of the first tensioning arm 2 and consequently, a larger opening of the opening angle 10 is possible, particularly when the tensioning pulleys 6, 8 are in an otherwise same position. This additionally favors the maintenance of a good wrap angle and allows further reduction in the force required for tensioning the two tensioning arms 2, 3.

However, it is also possible to provide an angle 18 that is greater than 175° or even an angle of 180° between the first and the third lines 11, 17. In other embodiments, it would also be possible to provide an angle of 140° to 175° or greater between the third and the first lines 17, 11 on both sides of the second tensioning pulley 8. Generally speaking, the angle 18 between the first and the third lines 11, 17 can be in the range of 180°+/−40°.

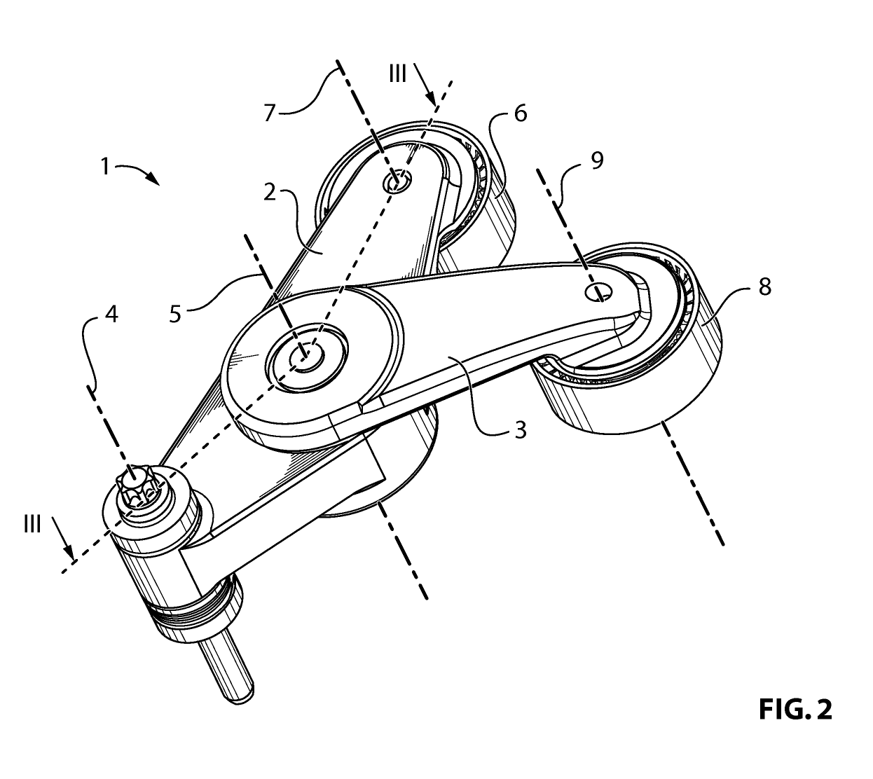

FIG. 2 is a perspective view of the tensioner 1 of the invention. It can be seen clearly that a spring that tensions the tensioning arms and that is accommodated in the region of the second pivot axis 5 occupies less installation space. Thus the lesser the spring force required for tensioning purposes and thus the weaker the necessary spring itself, the smaller the required installation space. That is, the design of the tensioner 1 suggested by the preferred embodiment and the resulting reduction in the necessary tensioning force also leads to a reduction in construction volume.

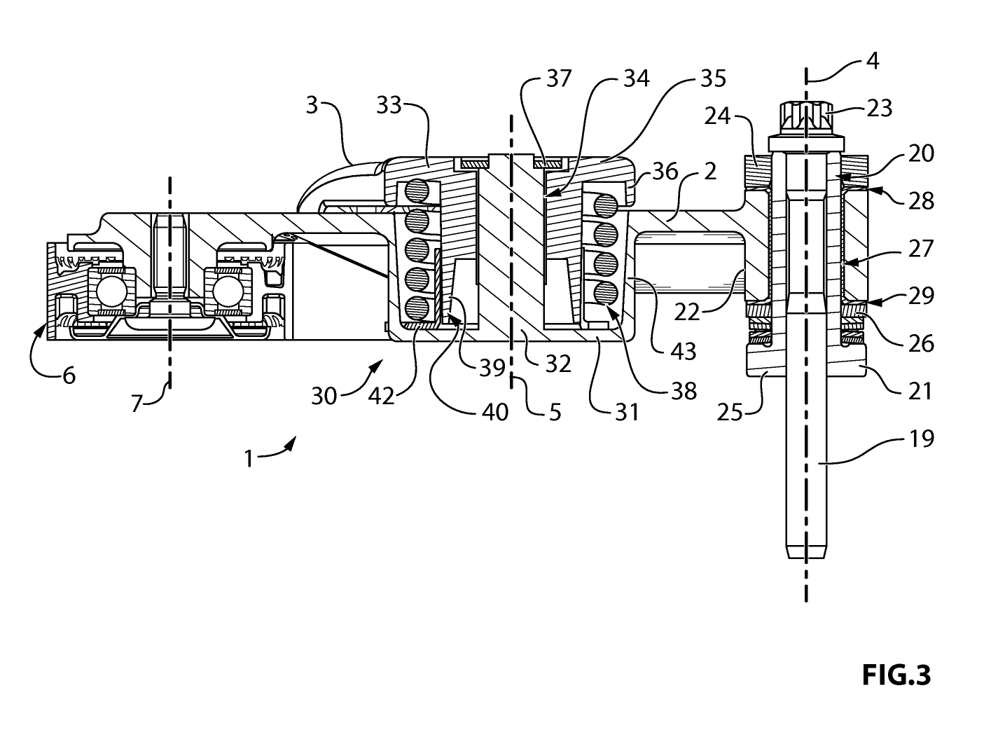

FIG. 3 is a cross-sectional view of the tensioner 1 taken along a line III-III marked in FIG. 2. The tensioner 1 can be mounted, for example, on an internal combustion engine by means of a mounting screw 19 extending through a bearing bolt 20 on which a base plate 21 is provided integrally. The bearing bolt 20 extends through a bearing eye 22 of the first tensioning arm 2. The bearing bolt 20 extends further on the side of a head 23 of the mounting screw 19 through a front plate 24. On the opposite side, the bearing bolt 20 extends additionally through a laminated disk spring 25 resting against the base plate 21 and through a pressing disk 26 resting against the laminated disk spring 25. Between the bearing eye 22 and the bearing bolt 20 there is provided a bearing bush 27 that has radially outwardly extending flanges 28, 29 at its opposing ends. The bearing bush 27 is a one-part component in this embodiment of the invention, but it can also be bipartite.

The bearing bush 27 has a dual function. First, it supports the first tensioning arm 2 so as to be free to rotate. Second, it damps its rotational movement by means of friction damping. More particularly, the friction damping is produced with the help of the two flanges 28, 29, the laminated disk spring 25 pressing the friction partners of the flanges 28, 29 against the same, namely the front plate 24 and the bearing eye 22 on the one hand and the pressing disk 26 and the bearing eye 22 on the other.

Instead of the flanges 28, 29, provision can also be made for separate damping disks for the bearing bush 27 that can be in the form of Teflon-coated steel disks, for example. See, for example, U.S. Publication No. 2008/0280713, the contents of which are incorporated herein by reference in their entirety.

The first tensioning arm is freely rotatable about the first pivot axis 4, that is, without being spring-loaded.

The first tensioning arm 2 comprises an approximately cup-shaped spring housing 30. A second bearing bolt 32 extends integrally from a base 31 of the spring housing. The second bearing bolt 32 extends through a bearing eye 33 of the second tensioning arm 3. Between the bearing eye 33 and the second bearing bolt 32 there is provided a second bearing bush 34 by means of which the second tensioning arm 3 is mounted on the second bearing bolt 32 so as to be free to rotate. A spring cover 35 comprising a collar 36 that protrudes axially toward the base 31 extends radially outwards from the bearing eye 33 of the second tensioning arm 3. The bearing eye 33 and the spring cover 35 formed integrally therewith are secured by a second front plate 37 axially on the second bearing bolt 32 against an axial force of a coil spring 38.

In the present embodiment, the second bearing bolt 32 is cylindrical in shape. It is also possible to provide a cone bearing instead that tapers in the direction extending away from the base 31. Instead of the cylindrically hollow second bearing bush 34, a bearing bush tapering in the direction extending away from the base 31 would then be provided and an internal peripheral surface of the bearing eye corresponding to the external peripheral surface of this bearing bush would likewise taper in the direction extending away from the base 31. An example of such structure is found in U.S. Pat. No. 4,698,049, the contents of which are incorporated by reference herein in their entirety.

The coil spring 38 loads the tensioning arms 2, 3 toward each other. The stronger the tensioning arms 2, 3 are pushed apart by belt forces, the greater is the reduction in the diameter of the coil spring 38. As a result, the coil spring strongly wraps around a slotted damping bush 40 provided between the coil spring and an axial extension 39 of the bearing eye 33. That is, the coil spring 38 increases the force with which the damping bush 40 rubs against the bearing eye 33 of the second tensioning arm 3, more particularly against its axial extension 39, as a result of which the damping force increases. A bottom end 41 of the coil spring 38 is provided for a radially outwardly extending flange 42 of the damping bush 40 for rotation therewith.

Alternatively, the spring 38 could be provided such that it widens radially when the tensioning arms 2, 3 are pushed apart by belt forces. Then a damping bush can be provided between the coil spring and a cylinder wall 43 of the spring housing 30 and said damping bush can rotate relative to the cylinder wall 43 and rub against the same when the tensioning arms pivot relative to each other. An example of such structure is found in U.S. Pat. No. 8,142,314, the contents of which are incorporated by reference herein.

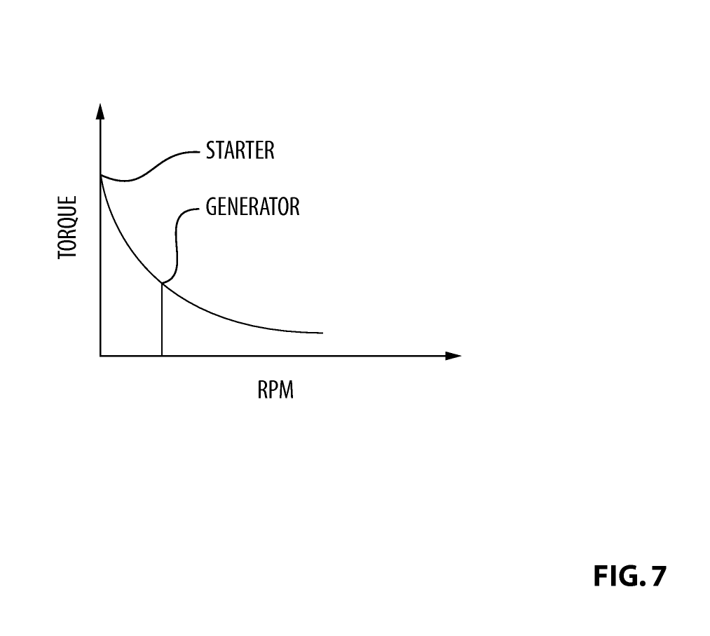

FIGS. 4 to 6 show a simulation model of an exemplary belt drive arrangement 50 and a simulation model of the preferred tensioner 1 in various operating states. By way of example, the belt drive arrangement comprises a crankshaft belt pulley 51 connected to a crankshaft of an internal combustion engine, a belt pulley 52 of a starter-generator unit and an additional belt pulley 53 that can be connected to an air-conditioning compressor, for example. In this example, the starter-generator unit is an electric generator for generating electricity and it can also operate as an electric motor for starting the engine. FIG. 7 schematically shows a representative torque curve for a conventional starter-generator unit from which it will be appreciated that when the unit operates as a motor the peak torque on belt pulley 52 is quite high and when the unit operates as a generator the peak torque on belt pulley 52 is relatively lower.

A belt 54 is guided around the belt pulleys in the form of an endless drive. The belt 54 is tensioned in that the first tensioning pulley 6 rests against a first belt portion 55 that extends between the crankshaft belt pulley 51 and the belt pulley 52 of the starter-generator unit and in that the second tensioning pulley 8 rests against a second belt portion 56 that extends between the belt pulley 52 of the starter-generator unit and the belt pulley 53 of the air-conditioning compressor. The tensioning pulleys 6, 8 press against the belt portions 55, 56 from the outside.

In FIG. 4, the tensioner 1 is in a tensioning initial position. The engine is running and the generator load of the starter-generator unit is zero, i.e., the system is in a quasi-static state. Note that in this state the hub load force 58 (the load on the shaft of pulley 52) is directed substantially along a line that passes through the first pivot axis 4.

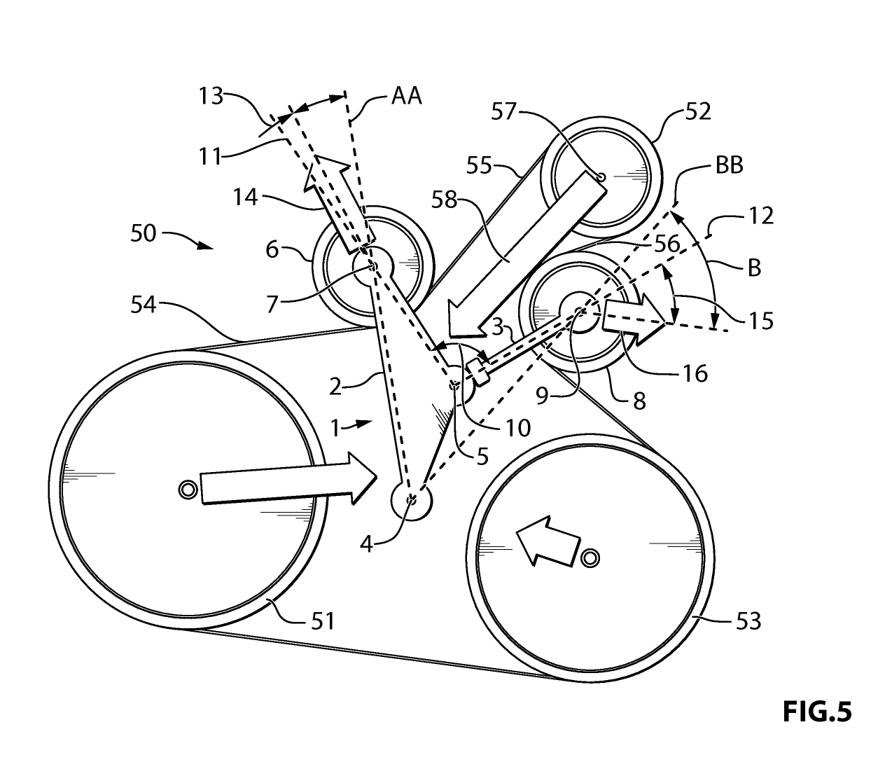

When the starter-generator unit is employed in a boost function in order to additionally drive the crankshaft to start the engine, the starter-generator unit must drag the engine by means of the crankshaft belt pulley 51. The first belt portion 55 becomes the tight side and it is tensioned. By contrast, the second belt portion 56 becomes the slack side and it is relieved of tension. The tensioner 1 pivots about the first pivot axis 4 toward the first belt portion 55 and it thus compensates the resulting longitudinal shift of the belt portions, namely the shortening of the first belt portion 55 and the lengthening of the second belt portion 56. After the pivoting movement, the tensioner 1 is in a position as seen in FIG. 5 that differs from the initial position shown in FIG. 4. The first angle 13 between a first hub load force 14 on the first pulley 6 and the first line 11 has dropped to a value of less than 30°, even a value less than 25° in the present exemplary embodiment. Likewise, the angle α between force 14 and line AA has dropped. Thus a significant component of the first hub load force 14 is absorbed in the form of a tensile force by the first tensioning arm 2 and by the bearing that is part of the first pivot axis 4. Only a small component of the first resulting force acts at right angles to the first line 11 or line AA and it must be absorbed by the coil spring 38 tensioning the two tensioning arms, the second tensioning arm 3 being supported appropriately by means of its second tensioning pulley 8 against the second belt portion 56.

A second hub load force 16 acting on the second tensioning pulley 8 is small and the necessary tension in the second belt portion 56 is maintained easily by the coil spring 38.

The opening angle 10 is substantially constant as compared to the illustration shown in FIG. 4. It has opened only slightly by less than 10°, and by less than 5° in the present exemplary embodiment. Thus the wrap angle of the belt 54 around the belt pulley 52 remains substantially constant so that the force-transmission capacity between the belt 54 and the belt pulley 52 is substantially constant.

A similar operating state as the one shown in FIG. 5 occurs when the engine is started by the starter-generator unit.

The starter-generator unit must be driven by the internal combustion engine by means of the belt 54 when it switches from the starter or engine mode to the generator mode. The second belt portion 56 becomes the tight side and it is tensioned. By contrast, the first belt portion 55 becomes the slack side and it is relieved of tension.

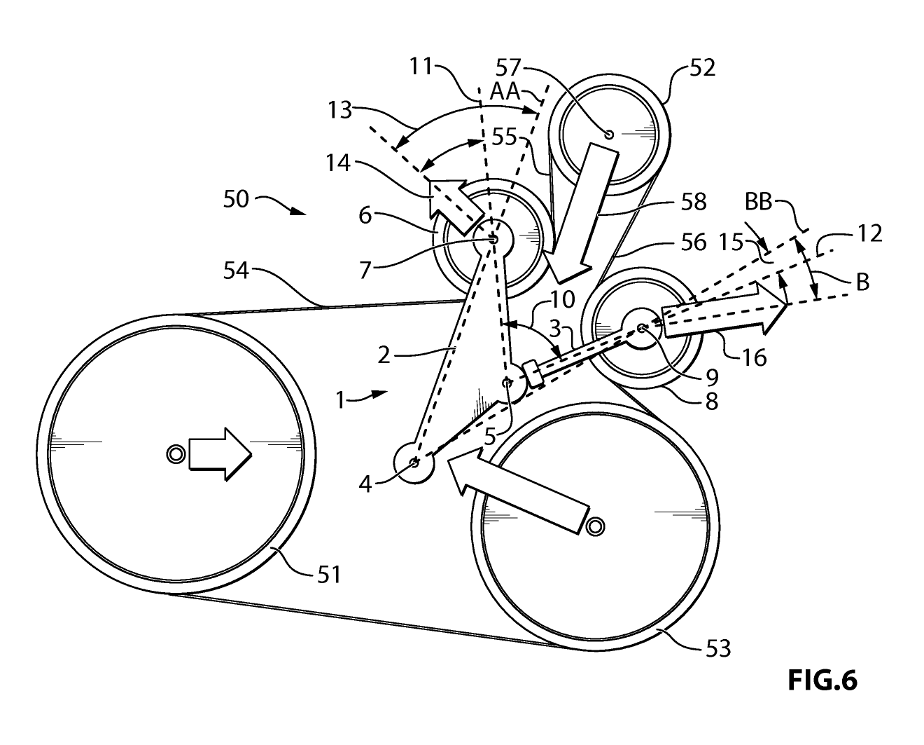

The tensioner 1 pivots about the first pivot axis 4 toward the second belt portion 56 and it thus compensates the longitudinal shift of the belt portions, namely the shortening of the second belt portion 56 and the lengthening of the first belt portion 55. On completion of the pivoting movement, the tensioner 1 achieves a second position as seen in FIG. 6 that differs from the initial position shown in FIG. 4. The second hub load force 16 is greater than the first hub load force 14. The second angle 15 has reduced to a value that is clearly less than 30°, and even to a value less than 20°. In the illustrated embodiment, it is less than 15°. Likewise the angle β between force 16 and line BB has dropped in comparison to FIG. 4. As a result, the orthogonal component about the pivot axis 5 is reduced, reducing the tendency of the arms 2,3 to open for a given unit force. In addition, a significant component of the second hub load force 16 is introduced in the form of a tensile force into the second tensioning arm 3 and into the first tensioning arm 2 by means of the bearing that is part of the second pivot axis 5. This force is absorbed, on the one hand, by the bearing that is part of the fixed first pivot axis 4 and, on the other hand, by virtue of the fact that the first tensioning arm 2 is supported against the first belt portion 55 by means of the first tensioning pulley 6. In spite of that, the first hub load force 14 is less than the second hub load force 16. The coil spring 38 can easily compensate the orthogonal components of the hub load forces 14, 16 that push the tensioning arms apart.

The eccentric arrangement of the second pivot axis 5 helps in this arrangement because a significant component of the second hub load force 16 is directed along line BB passing through the first pivot axis 4, which is fixed in position.

The system shown in FIGS. 4-6 can be mathematically understood by the following simplified equations.

The torque about pivot axis 4, which sets the angular position of the system as a whole, is

\vec{L_{4,7}}×\vec{F₁₄}+\vec{L_{4,9}}×\vec{F₁₆}=0, or

L_{4,7}·F₁₄·sin α=L_{4,9}·F₁₆·sin β

where L_{4,7} is a vector between axes 4 and 7; L_{4,9} is a vector between axes 4 and 9.

The torque about pivot axis 5, which determines the opening angle 10, is

\vec{L_{5,9}}×\vec{F₁₆}=k·(θₚ+θ₁₀), or

L_{5,9}·F₁₆·sin θ₁₅=k·(θₚ+θ₁₀)

where L_{5,9} is a vector between axes 5 and 9; θ₁₀ is the opening angle 10 and θₚ is a preload angle (in the case where the spring delivers a preload torque).

From the foregoing it will be seen that when the tensioner switches to the second position, the opening angle 10 does not alter substantially. As compared to the operating state shown in FIG. 5, the opening angle 10 has reduced here by less than 10° and even by less than 5° in this case. This contributes toward maintaining a good wrap angle.

The wrap-around angle of the belt pulley 52 of the starter-generator unit has increased additionally as a result of the geometry of the tensioner and the positioning of the pivot axis 4. The first pivot axis 4 is provided at a position in which the first tensioning pulley 6 reduces its distance from the belt pulley 52 of the starter-generator unit when the tensioner 1 pivots from the first position (FIG. 5) into the second position (FIG. 6). The first axis of rotation 7 pivots toward a line (not referenced in the drawings) between the first pivot axis 4 and an axis of rotation 57 of the belt pulley 52.

In addition, the geometry of the tensioner may be selected such that the distance of the second axis of rotation 9 from the pivot axis 4 is somewhat smaller than the distance of the first axis of rotation 7 from the first pivot axis 4. Thus the first tensioning pulley 6 draws close to the belt pulley 52 of the starter-generator unit more strongly than the second tensioning pulley 8 moves away from the belt pulley 52 of the starter-generator unit when the tensioner pivots into the second position.

In the preferred embodiment, the first tensioning arm 2 is assigned to the strand in which maximum belt tension occurs during the operation of the belt drive arrangement, namely the first belt portion 55. Thus a significant component of the maximum resulting force is introduced in the form of tensile force into the first tensioning arm 2 and is directly absorbed by the bearing of the tensioner 1 that is part of the first pivot axis 4. This likewise contributes toward a reduction in the spring force required for tensioning the two tensioning arms.

From the foregoing, it will be appreciated that a tensioner according to the invention can maintain a good wrap angle around an endless driving wheel by means of the tensioning arms that are spring-loaded toward each other even during a changeover between the tight side and the slack side, and the tensioner can effectively compensate longitudinal shifts in portions of the endless drive accompanying this changeover by means of the eccentricity between the first and the second pivot axes. Furthermore, it is possible for this tensioner at the same time to realize a moderate level of basic tension of the endless drive.

The tensioner can be moved between a first position, in which, when the first strand is the tight side, a resulting force on the first tensioning pulley and a line connecting the second pivot axis to the first axis of rotation forms a first angle that is smaller than 30°, and a second position, in which, when the second strand is the tight side, a resulting force on the second tensioning pulley and a line connecting the second pivot axis to the second axis of rotation forms a second angle that is smaller than 30°. By virtue of the fact that the first angle is smaller than 30° when the first strand is the tight side and the second angle is smaller than 30° when the second strand is the tight side, a considerable component of the resulting force in question is absorbed by the respective tensioning arm in the form of a tensile force. Thus less spring force is required for tensioning the two tensioning arms. The basic tension level of the endless drive is reduced as a result of the reduced spring tension force.

Advantageously, the first angle in the first position and/or the second angle in the second position can be smaller than 25°, preferably smaller than 20°, and even more preferably smaller than 15°. The smaller the angle, the higher is the component of the resulting force that can be absorbed by the tensioning arm in question in the form of a tensile force. Accordingly, it is possible to use a smaller amount of spring tension force for tensioning the two tensioning arms, as a result of which the level of basic tension of the endless drive can be reduced still further. In spite of that, the tensioner is able to effectively attenuate tension peaks in the endless drive.

Preferably, the first tensioning arm can be assigned to the strand, in which the maximum tension occurs during the operation of the endless drive arrangement. Thus a large component of the resulting force on the first tensioning pulley can be absorbed by the bearing of the tensioner on the first pivot axis. Thus a smaller amount of spring force is sufficient for tensioning the tensioning arms, as a result of which the level of basic tension of the endless drive can be reduced.

Advantageously, an angle formed between a line connecting the second pivot axis to the first axis of rotation and a line connecting the second pivot axis to the second axis of rotation during a movement of the tensioner from a first position, in which the first strand is the tight side, into a second position, in which the second strand is the tight side, and/or vice versa remains substantially constant. Thus only a small amount or no amount of spring work is required during a changeover between the tight side and the slack side, and the wrap angle around the endless driving wheel remains substantially constant.

Very advantageously, the angle can alter by less than 10°, and preferably by less than 5°. The smaller the amount by which the angle alters, the lesser is the spring work required and the better is the wrap angle retained.

Very advantageously, an angle formed between a line connecting the second pivot axis to the first axis of rotation and a line connecting the second pivot axis to the second axis of rotation can range from approximately 60° to 90°. Thus force can be absorbed effectively on the respective tensioning arm tensioning the tight side, a considerable component of the resulting force on the tensioning pulley in question being absorbed in the form of a tensile force by the tensioning arm in question, as a result of which it is possible to apply lesser spring force to the tensioning arms.

Advantageously, the endless driving wheel can be part of that equipment assembly of the endless drive arrangement which has the greatest moment of inertia and/or the greatest rotational non-uniformities. Thus longitudinal shifts in the endless drive can be compensated very effectively.

Preferably, the endless driving wheel can be part of the starter-generator unit. In a starter-generator unit, the strand switches between the tight side and the slack side during a changeover of the starter-generator unit from the starter mode to the generator mode and vice versa. Thus the accompanying longitudinal shifts in the endless drive are compensated at the locus of their origin.

Preferably, the distance of the first pivot axis from the second pivot axis can be at least a quarter of the distance of the second pivot axis from the first axis of rotation and/or the second axis of rotation. Thus the tensioner of the invention achieves a performance characteristic that differs clearly from that of a conventional two-armed tensioner comprising tensioning arms disposed in a V-shaped arrangement, that is to say, comprising only one pivot axis. As a result of the reduction in the distance between the axes of rotation from the pivot axis responsible for the relative rotation of the tensioning arms, the angle between a line connecting the first axis of rotation to the second pivot axis and a line connecting the second axis of rotation to the second pivot axis is large enough to absorb a considerable component of the resulting force of the tensioning pulley that tensions the tight side by means of the articulated connection of the second pivot axis. As a result, lesser spring tension force is required for tensioning the endless drive, that is to say, a clearly reduced level of basic tension is possible in the endless drive. At the same time, the aforementioned geometry contributes toward maintaining a good wrap angle. In spite of that, the tensioner is able to effectively attenuate tension peaks occurring in the endless drive. By means of the distance between the first and the second pivot axes, the tensioner can compensate longitudinal shifts in the endless drive when there is a changeover between the tight side and the slack side. Consequently, such a tensioner of the invention enables distances to be realized between the axes of rotation and the second pivot axis, which would have made it difficult for a conventional tensioner comprising tensioning arms disposed in a V-shaped arrangement and only one pivot axis or a tensioner behaving almost like such a V-shaped tensioner to effectively compensate longitudinal shifts in the endless drive during a changeover between slack side and tight side without excessively reducing the wrap angle or without excessively increasing the level of basic tension of the endless drive.

Advantageously, the distance of the first pivot axis from the second pivot axis can be at least a third, preferably at least half of the distance of the second pivot axis from the first axis of rotation and/or the second axis of rotation. The wrap angle can then be retained even better and the spring tension force required for tensioning the two tensioning arms can be reduced still further. At the same time, the tensioner compensates longitudinal shifts in the endless drive effectively.

Very preferably, the distance of the first pivot axis from the second pivot axis can be approximately as large as the distance of the second pivot axis from the first axis of rotation and/or the second axis of rotation. In this arrangement, the wrap angle can be maintained particularly effectively, it being possible for the force required for tensioning the two tensioning arms to be reduced once again. At the same time, the tensioner can effectively compensate tension peaks and longitudinal shifts in the endless drive during a changeover between the tight side and the slack side.

Advantageously, a line connecting the first and second pivot axes and a line connecting the second pivot axis to the first axis of rotation form an obtuse angle, preferably an angle ranging from approximately 140° to 175°. As a result, the length of the second tensioning arm can be shorter compared to a stretched form of the first tensioning arm, and a greater opening of the angle between the two tensioning arms is possible consequently. This proves advantageous for maintaining a good wrap angle and enables a further reduction in the force required for tensioning the two tensioning arms.

Very advantageously, provision can be made for a damping bush along a periphery of a coil spring that spring-loads the first and the second tensioning arms relative to each other, and the coil spring presses against this damping bush radially when its diameter alters during a movement of the tensioning arms relative to each other. Thus a damping effect is achieved that alters increasingly with the increasing change in the diameter of the coil spring.

Very preferably, the distance of the first pivot axis from the second pivot axis can be at least a third, and even more preferably at least half of the distance of the second pivot axis from the first axis of rotation and/or the second axis of rotation.

Very advantageously, the distance of the first pivot axis from the second pivot axis can be approximately as large as the distance of the second pivot axis from the first axis of rotation and/or the second axis of rotation.

Advantageously, a line connecting the first and the second pivot axes and a line connecting the second pivot axis to the first axis of rotation form an obtuse angle, preferably an angle ranging from approximately 140° to 175°.

Very advantageously, an angle formed between a line connecting the second pivot axis to the first axis of rotation and a line connecting the second pivot axis to the second axis of rotation can range from approximately 60° to 90°.

Very preferably, provision can be made for a damping bush along a periphery of a coil spring that spring-loads the first and the second tensioning arms relative to each other, and the coil spring presses against this damping bush radially when its diameter alters during a movement of the tensioning arms relative to each other.

Those skilled in the art will appreciate that a variety of modifications may be made to the embodiments described herein without departing from the fair meaning of the accompanying claims.

1. An endless drive arrangement (50) for an internal combustion engine, comprising:
an endless drive (54) guided around an endless driving wheel (52) of the endless drive arrangement (50);
a starter-generator unit connected to the endless driving wheel (52);
a tensioner (1) comprising a first tensioning arm (2) and a second tensioning arm (3), the first and the second tensioning arms (2, 3) being pivotable about a common first pivot axis (4), wherein the second tensioning arm (3) is articulated to the first tensioning arm (2) so as to be spring-loaded and pivotable about a second pivot axis (5) located at a distance from the first pivot axis (4);
a first tensioning pulley (6) rotationally connected to the first tensioning arm (2) about a first axis of rotation (7), the first tensioning pulley (6) resting against a first strand (55) of the endless drive (54) so as to tension the same; and
a second tensioning pulley (8) rotationally connected to the second tensioning arm (3) about a second axis of rotation (9), the second tensioning pulley (8) resting against a second strand (56) of the endless drive (54) so as to tension the same;
wherein the first strand (55) becomes a tight side of the endless drive (54) when the starter-generator unit operates as a starter and the second strand (56) becomes the tight side when the starter-generator unit operates as a generator.

2. An endless drive arrangement (50) according to claim 1, wherein the tensioner (1) can be moved between a first position, in which, when the first strand (55) is the tight side, a resulting force (14) on the first tensioning pulley (6) and a line between the first pivot axis (4) to the first axis of rotation (7) form a first angle (13) that is smaller than 30°, and a second position, in which, when the second strand (56) is the tight side, a resulting force (16) on the second tensioning pulley (8) and a line (12) connecting the second pivot axis (5) to the second axis of rotation (9) form a second angle (15) that is smaller than 30°.

3. An endless drive arrangement according to claim 2, wherein the first angle (13) in the first position is smaller than 25° and the second angle (15) in the second position is smaller than 25°.

4. An endless drive arrangement according to claim 3, wherein the first angle (13) in the first position is smaller than 20° and the second angle (15) in the second position is smaller than 20°.

5. An endless drive arrangement according to claim 4, wherein the first angle (13) in the first position is smaller than 15° and the second angle (15) in the second position is smaller than 15°.

6. An endless drive arrangement according to claim 1, wherein the first tensioning arm (2) is assigned to the strand (55), in which the maximum endless drive tension occurs during the operation of the endless drive arrangement (50).

7. An endless drive arrangement according to claim 1, wherein an opening angle (10), which is formed between a first line (11) connecting the second pivot axis (5) to the first axis of rotation (7) and a second line (12) connecting the second pivot axis (5) to the second axis of rotation (9) remains substantially constant during a movement of the tensioner (1) between a first position, in which the first strand (55) is the tight side, and a second position in which the second strand (56) is the tight side.

8. An endless drive arrangement according to claim 7, characterized in that the opening angle (10) alters by less than 10°.

9. An endless drive arrangement according to claim 7, wherein the opening angle (10) is in the range of approximately 60° to 90°.

10. An endless drive arrangement according to claim 1, wherein the distance between the first pivot axis (4) and the second pivot axis (5) is at least a quarter of the distance between the second pivot axis (5) and one of the first axis of rotation (7) and the second axis of rotation (9).

11. An endless drive arrangement according to claim 10, wherein the distance between the first pivot axis (4) and the second pivot axis (5) is at least a third of the distance between the second pivot axis (5) and one of the first axis of rotation (7) and the second axis of rotation (9).

12. An endless drive arrangement according to claim 11, wherein the distance between the first pivot axis (4) and the second pivot axis (5) is substantially as large as the distance between the second pivot axis (5) and one of the first axis of rotation (7) and the second axis of rotation (9).

13. An endless drive arrangement according to claim 1, wherein a line (17) connecting the first and the second pivot axes (4, 5) and a line (11) connecting the second pivot axis (5) to the first axis of rotation (7) form an obtuse angle (18)in the range of approximately 140° to 175°.

14. An endless drive arrangement according to claim 1, wherein a coil spring (38) spring-loads the first and the second tensioning arms (2, 3) relative to each other, and a damping bush (40) is disposed along the periphery of the coil spring (38) which presses radially against the damping bush (40) as the diameter of the coil spring (38) alters during a movement of the tensioning arms (4, 5) relative to each other.

15. A tensioner (1) for an endless drive (54), comprising:
a first tensioning arm (2) pivotable about a first pivot axis (4);
a first tensioning pulley (6) mounted on the first tensioning arm (2) for rotation about a first axis of rotation (7);
a second tensioning arm (3) articulated to the first tensioning arm (2) about a second pivot axis (5) located at a distance from the first pivot axis (4);
a second tensioning pulley (8) mounted on the second tensioning arm (3) to rotate about a second axis of rotation (5); and
a coil spring (38) connected between the first and second tensioning arms (2,3) for biasing the first and second tensioning arms towards each other;
wherein the distance (D1) between the first pivot axis (4) and the second pivot axis (5) is at least a quarter of the distance (D2 or D3) between the second pivot axis (5) and one of the first axis of rotation (7) and the second axis of rotation (9).

16. The tensioner according to claim 15, wherein the distance between the first pivot axis (4) and the second pivot axis (5) is approximately as large as the distance between the second pivot axis (5) and one of the first axis of rotation (7) and the second axis of rotation (9).

17. The tensioner according to claim 15, wherein, when the tensioner is not externally stressed, a line (17) connecting the first and the second pivot axes (4, 5) and a line (11) connecting the second pivot axis (5) to the first axis of rotation (7) form an an angle in the range of approximately 140° to 175°.

18. The tensioner according to claims 15, wherein, when the tensioner is not externally stressed, an angle (10) formed between a line (11) connecting the second pivot axis (5) to the first axis of rotation (7) and a line (12) connecting the second pivot axis (5) to the second axis of rotation (9) is in the range of approximately 60° to 90°.

19. The tensioner according claim 15, including a damping bush (40) disposed along the periphery of the coil spring (38) that spring-loads the first and the second tensioning arms (2, 3) relative to each other, wherein the coil spring (38) presses radially against the damping bush (40) as the diameter of the coil spring (38) alters during a movement of the tensioning arms (2, 3) relative to each other.

20. An endless drive arrangement for an internal combustion engine, comprising:
an endless drive guided around an endless driving wheel of the endless drive arrangement;
a starter-generator unit connected to the endless driving wheel;
a tensioner comprising a first arm and a second arm, the first and the second arms being pivotable about a common first pivot axis, wherein the second arm is articulated to the first arm and pivotable about a second pivot axis located at a distance from the first pivot axis;
a coil spring connected between the first and second arms so as to bias the arms towards each other;
a first pulley rotationally connected to the first arm about a first axis of rotation, the first pulley resting against a first strand of the endless drive so as to tension the endless drive; and
a second pulley rotationally connected to the second arm about a second axis of rotation, the second pulley resting against a second strand of the endless drive so as to tension the endless drive;
wherein the first strand becomes a tight side of the endless drive when the starter-generator unit operates as a starter and the second strand becomes the tight side when the starter-generator unit operates as a generator; and
wherein the first pivot axis is fixed relative to the engine at a position that is substantially in line with a hub force vector experienced by the endless drive wheel when the starter generator unit is in a quasi-static mode of operation.

21. An endless drive arrangement for an internal combustion engine, comprising:
an endless drive guided around an endless driving wheel of the endless drive arrangement;
a starter-generator unit connected to the endless driving wheel;
a tensioner comprising a first arm and a second arm, the first and the second arms being pivotable about a common first pivot axis, wherein the second arm is articulated to the first arm so as to be pivotable about a second pivot axis located at a distance from the first pivot axis;
a coil spring connected between the first and second arms so as to bias the arms towards each other;
a first pulley rotationally connected to the first arm about a first axis of rotation, the first pulley resting against a first strand of the endless drive so as to tension the endless drive; and
a second pulley rotationally connected to the second arm about a second axis of rotation, the second pulley resting against a second strand of the endless drive so as to tension the endless drive;
wherein the first strand becomes a tight side of the endless drive when the starter-generator unit operates as a starter and the second strand becomes the tight side when the starter-generator unit operates as a generator; and
wherein the first pivot axis is fixed relative to the engine and the second pivot axis floats relative to the engine, the second pivot axis being positioned away from a line between the first pivot axis and the first axis of rotation and wherein the distance between the first pivot axis and the second pivot axis is at least a third of the distance between the second pivot axis and one of the first axis of rotation and the second axis of rotation.

22. An endless drive arrangement for an internal combustion engine, comprising:
an endless drive guided around an endless driving wheel of the endless drive arrangement;
a starter-generator unit connected to the endless driving wheel;
a tensioner comprising a first arm and a second arm, the first and the second arms being pivotable about a common first pivot axis, wherein the second arm is articulated to the first arm so as to be pivotable about a second pivot axis located at a distance from the first pivot axis;
a coil spring connected between the first and second arms so as to bias the arms towards each other;
a first pulley rotationally connected to the first arm about a first axis of rotation, the first pulley resting against a first strand of the endless drive so as to tension the endless drive; and
a second pulley rotationally connected to the second arm about a second axis of rotation, the second pulley resting against a second strand of the endless drive so as to tension the endless drive;
wherein the first strand becomes a tight side of the endless drive when the starter-generator unit operates as a starter and the second strand becomes the tight side when the starter-generator unit operates as a generator; and
wherein the first pivot axis is fixed relative to the engine and the second pivot axis floats relative to the engine, the first pivot axis being situated at a position that is substantially in line with a hub force vector experienced by the endless drive wheel when the starter generator unit is in a quasi-static mode of operation, the second pivot axis being positioned away from a line between the first pivot axis and the first axis of rotation, and wherein the distance between the first pivot axis and the second pivot axis is at least a third of the distance between the second pivot axis and one of the first axis of rotation and the second axis of rotation.
